(19) United States
(12) Patent Application Publication
(10) Pub. No.: US 2010/0192802 A1
(43) Pub. Date: Aug. 5, 2010

(54) REINFORCED METAL OXIDE FLAKES FOR EFFECT PIGMENTS

(75) Inventors: Patrice Bujard, Courtepin (CH); Redina Kote, South Salem, NY (US); Philippe Bugnon, Le Mouret (CH)

Correspondence Address: BASF Performance Products LLC;Patent Department, 540 White Plains Road, P.O. Box 2005, Tarrytown, NY, 10591, US

(73) Assignee: CIBA CORPORATION, Tarrytown, NY (US)

(21) Appl. No.: 12/597,498

(22) PCT Filed: Apr. 23, 2008
(86) PCT No.: PCT/EP2008/054877

§ 371 Date: Apr. 8, 2010

(30) Foreign Application Priority Data
May 2, 2007 (EP) 07107303.5

(51) Int. Cl. C09B 67/08; C08K 3/30; C08K 3/28; C08K 3/22; B05D 7/00

(52) U.S. Cl. 106/31.65; 106/482; 524/420; 524/428; 524/401; 427/218

(57) ABSTRACT

The present invention relates to a method for preparing (pearlescent) pigments, comprising the steps of: (1) coating of a sheet silicate with a desired metal oxide, wherein coated flakes are obtained, (2) delamination of the coated flakes obtained in step (1), wherein exfoliated coated flakes and exfoliated non-coated flakes are obtained, (3) separation of the exfoliated coated flakes from the exfoliated non-coated flakes, (4) coating the exfoliated coated flakes obtained in step (3) with metals, metal oxides, metal sulfides, metal nitrides or mixtures thereof, wherein a (pearlescent) pigment is obtained; to (pearlescent) pigments, obtainable by the process and to the use of the (pearlescent) pigments in paints, ink-jet printing, for dyeing textiles, for pigmenting coatings, printing inks, plastics, cosmetics, glazes for ceramics and glass.

The present invention relates to a method for preparing (pearlescent) pigments, to (pearlescent) pigments, obtainable by the process and to the use of the (pearlescent) pigments in paints, ink-jet printing, for dyeing textiles, for pigmenting coatings, printing inks, plastics, cosmetics, glazes for ceramics and glass.

U.S. Pat. No. 4,676,929 describes a method of delamination wherein a hydrated phyllosilicate is dispersed in an expanding agent. This may be a primary aminocarboxy acid, or lysine orotate, or glycylglycine. When accompanied by a shearing force, the expanding agent is effective to separate the silicate layer units of the phyllosilicate crystal in a matter of minutes, and form a gel at ambient temperature.

U.S. Pat. No. 4,715,987 describes subjecting a phyllosilicate to an ion exchange treatment before reacting it with an expanding agent in accordance with U.S. Pat. No. 4,676,929. U.S. Pat. No. 4,786,620 describes subjecting a phyllosilicate to an ion exchange treatment, plus a thermal treatment. This develops a new crystal phase which forms a solid solution.

U.S. Pat. No. 4,826,628 describes a method of delaminating a phyllosilicate by heating the phyllosilicate in the presence of a reactive vapor phase. Preferably, this is a hydrogen-containing atmosphere, such as forming gas. The delaminated phyllosilicate is stabilized against moisture pickup, and may have a layer of transition metal, or organic reactive sites, formed on its surface.

U.S. Pat. No. 4,400,297 discloses producing a modified, heat exfoliated, hydrated magnesium aluminosilicate in particulate form by treating the aluminosilicate with an aqueous acidic solution having a pH between 1.0 and 5.5, while simultaneously subjecting the mass to a controlled shearing action. The patent further discloses that when a non-heat exfoliated vermiculite was subjected to a similar acid and shearing treatment, the resulting material did not have the same appearance and did not form self-supporting sheets when dried.

U.S. Pat. No. 6,689,205 discloses multilayer interference pigments composed of a mica substrate and alternating layers of high and low refractive index (mica/TiO₂/SiO₂/TiO₂). U.S. Pat. No. 6,656,259 discloses multilayer interference pigments composed of a SiO₂ substrate and alternating layers of high and low refractive index (SiO₂/TiO₂/SiO₂/TiO₂). The pigments of the present invention are distinguished from those described in U.S. Pat. No. 6,689,205 and U.S. Pat. No. 6,656,259 in that the substrate consists of a layer of a sheet silicate and a layer of a metal oxide of low refractive index.

Synthetic metal oxide platelets (flakes) are very thin materials featuring thicknesses lower than about 1 micron, or even less than 0.5 microns. In contrast to sheet silicates, like natural mica, such flakes are made of homogeneous bulk material and are, therefore, very brittle.

The present invention solves this issue in combining the optical properties of bulk metal oxide with the better mechanical properties of sheet silicates.

Accordingly, the present invention relates to a method for preparing a pearlescent pigment, comprising the steps of:

(1) coating of a sheet silicate with a desired metal oxide, wherein coated flakes are obtained,
(2) delamination of the coated flakes obtained in step (1), wherein exfoliated coated flakes and exfoliated non-coated flakes are obtained,
(3) separation of the exfoliated coated flakes from the exfoliated non-coated flakes,
(4) coating the exfoliated coated flakes obtained in step (3) with metals, metal oxides, metal sulfides, metal nitrides or mixtures thereof, wherein a (pearlescent) pigment is obtained; and to pearlescent pigments, obtainable by the process of the present invention.

A SiO₂ layer on a sheet silicate substrate features a stronger mechanical resistance. When the substrate made of sheet silicate is thin enough (<-50 nm), the material combination leads to better mechanical properties, while keeping the desired optical properties of the SiO₂. The best sheet silicate happens to be natural mica (muscovite or vermiculite).

The material combination can then be coated with metal oxides featuring index of refraction (n) higher than the index of refraction of SiO₂ or mica. One especially preferred material is TiO₂.

The metal oxide in step (1) is a metal oxide of low refractive index. A metal oxide of low refractive index is defined herein as a metal oxide having an index of refraction of about 1.65 or less. Examples are SiO₂, Al₂O₃, AlOOH, B₂O₃ or a mixture thereof. Most preferred is SiO₂.

The starting material in the method of the present invention is a sheet silicate (polymeric crystalline sodium disilicate) which can be easily exfoliated. Examples of such materials are natural mica (muscovite) and phyllosilicates (vermiculite).

The sheet silicate is usually subjected to a method for expanding mica-group minerals. Such a method is, for example, described in GB1375499 (U.S. Pat. No. 3,813,346) and is especially suitable for natural mica (muscovite) and phyllosilicates (vermiculite). The treatment according to GB1375499 is carried out by bringing the mica into contact with hydrogen peroxide in the presence of an acid. One may previously add an acid to the mica and then add hydrogen peroxide to the mixture; one may add a mixture of an acid and hydrogen peroxide to the mica mineral; one may add an acid and hydrogen peroxide separately and simultaneously to the mica; or one may add an acid to a mixture of hydrogen peroxide and the mica-group. In all cases, it is advantageous that these three materials are sufficiently admixed. The mica in the resulting mixture is effectively expanded by the action of hydrogen peroxide in the presence of an acid. During the reaction, stirring may be continued until the expansion of the mica-group mineral is completed.

The acid mentioned above is advantageously a mineral acid, such as sulphuric acid, phosphoric acid, hydrochloric acid, nitric acid, perchloric acid, chromic acid and silicic acid. The amount of acid depends upon its concentration and other factors, but generally from 0.01 to 1.0 mole of the acid is used relative to hundred grams of mica-group minerals.

Hydrogen peroxide is usually available on the market as a 35 weight percent aqueous 70 solution and such a solution may advantageously be employed. The higher the concentration of hydrogen peroxide, the higher is the degree of expansion which will be attained and the shorter is the expansion time required. While the proportion of hydrogen peroxide depends upon the amount of acid used and the desired degree of expansion, it usually ranges from 0.01 mol to 1 mole relative to hundred grams of mica. As previously mentioned, water is usually introduced in the reaction system as the carrier or vehicle for an acid and/or hydrogen peroxide, it is preferable that the amount of water relative to the reaction system be in a range from 35 weight percent to 45 weight percent.

In a typical example of U.S. Pat. No. 3,813,346 6 parts by volume of 98% concentrated sulphuric acid are added to 50 parts by weight of muscovite flakes and, after the system has been stirred evenly, 40 parts by volume of a 35% aqueous solution of hydrogen peroxide are added, whereupon the mineral expands to 700 parts by volume.

The expanded sheet silicate, such as, for example, muscovite or vermiculite, is milled and sieved to obtain particles with 50 to 500 microns in diameter and about 1 microns or more in thickness, which can be used as starting material in the process of the present invention.

The sheet silicate particles can be coated with a metal oxide of low refractive index in step (1) by the methods described below. In a preferred embodiment of the present invention in step (1) mica particles are dispersed in water in the presence of a cationic, anionic, nonionic or amphionic surfactant at an alkaline pH and at elevated temperature and a tetraalkoxy silane, such as tetraethoxy silane (TEOS), is added thereto, wherein a hydrous silicon oxide layer on the particles of the sheet silicate particles is formed.

Suitable anionic surfactants include carboxylates, isethionates, phosphate esters, sarcosinates, organic sulphates, is sulphosuccinates, sulphosuccinamates and taurates.

Suitable cationic surfactants include quaternary ammonium compounds, amine salts and imidazolium salts. Sulphonates are preferably used.

Examples of nonionic surfactants which can be used include alkanolamides, amine oxides, derivatives of carbohydrates, ethoxylated alkanolamides, ethoxylated long-chain amines, ethylene oxide/propylene oxide copolymers, ethoxylates of fatty acids, sorbitan derivatives, ethylene glycol esters, propylene glycol esters, glycerine esters and polyglycerin esters and ethoxylated derivatives thereof; alkylamines and alkylimidazolines, ethoxylated oils and fats, alkylphenol ethoxylates and acetylenic surfactants; alcohol ethoxylates being preferred.

Preferably, the dispersions contain 0.1 to 10% by weight, preferably 0.1 to 3% by weight based on the sheet silicate of nonionic surfactant(s).

In step (2) the water saturated SiO₂ coated mica flakes obtained in step (1) are mixed with a viscous liquid and treated with a three roll mill till SiO₂ coated exfoliated mica flakes are obtained. Preferred roll mill devices are those applying simultaneously shear and perpendicular forces to the flakes.

The viscous liquid has a dynamic viscosity at low shear rate of 0.1 and 50 s⁻¹ and/or a Brookfield viscosity of 0.1 to 10³ Pa*s, especially 0.1 to 100 Pa*s. The viscous liquid is selected from a mixture of sugar and water, or a polymer having OH groups. Examples of polymers having OH groups are polyvinylalcohols, like Mowiol® (Fluka), wherein the viscosity is adjusted by varying the molecular weight of the polyvinyl alcohol and its concentration. A mixture of a sugar, like melasse, or methylcellulose, and water is most preferred.

Then the exfoliated coated flakes are separated from the exfoliated non-coated flakes and dried. Preferably, the separation is done by sedimentation with a setup such that the slower sedimenting particles are removed from the container by a very low speed upward water flux. Drying is done at a temperature of 20 to 250° C.

The exfoliated coated flakes obtained in step (3) consist of a layer of a sheet silicate and a layer of a metal oxide of low refractive index. The thickness of the layer of the sheet silicate is from 300 to 0.1 nm, especially from 50 to 0.1 nm. The thickness of the layer of the metal oxide of low refractive index is from 50 to 500 nm, especially from 50 to 200 nm. Particularly preferred exfoliated coated flakes consist of a layer of SiO₂ having a thickness of 50 to 200 nm, especially from 50 to 150 nm and a layer of muscovite, or vermiculite having a thickness of 100 to 0.1 nm, especially from 50 to 1 nm. It is presently preferred that the diameter of the flakes be in a preferred range of about 1-60 μm with a more preferred range of about 5-40 μm. Thus, the aspect ratio of the flakes of the present invention is in a preferred range of about 5 to 3000. If a TiO₂ layer is deposited as a material of high refractive index, the TiO₂ layer has a thickness of 20 to 300 nm, especially 20 to 200 nm.

The exfoliated coated flakes obtained in step (3) (=substrate) can be coated with metals, metal oxides, metal sulfides, metal nitrides or mixtures thereof, wherein (pearlescent) pigments are obtained.

Suitable metals for the semi-transparent metal layer are, for example, Cr, Ti, Mo, W, Al, Cu, Ag, Au, or Ni. The semi-transparent metal layer has typically a thickness of between 5 and 25 nm, especially between 5 and 15 nm.

According to the present invention the term “aluminum” comprises aluminum and alloys of aluminum. Alloys of aluminum are, for example described in G. Wassermann in Ullmanns Enzyklopädie der Industriellen Chemie, 4. Auflage, Verlag Chemie, Weinheim, Band 7, S. 281 to 292. Especially suitable are the corrosion stable aluminum alloys described on page 10 to 12 of WO00/12634, which comprise besides of aluminum silicon, magnesium, manganese, copper, zinc, nickel, vanadium, lead, antimony, tin, cadmium, bismuth, titanium, chromium and/or iron in amounts of less than 20% by weight, preferably less than 10% by weight.

The metal layer can be obtained by wet chemical coating or by chemical vapor deposition, for example, gas phase deposition of metal carbonyls. The substrate is suspended in an aqueous and/or organic solvent containing medium in the presence of a metal compound and is deposited onto the substrate by addition of a reducing agent. The metal compound is, for example, silver nitrate or nickel acetyl acetonate (WO03/37993).

If pigments with metallic appearance are desired, the thickness of the metal layer is >25 nm to 100 nm, preferably 30 to 50 nm. If pigments with colored metal effects are desired, additional layers of colored or colorless metal oxides, metal nitrides, metal sulfides and/or metals can be deposited. These layers are transparent or semi-transparent. It is preferred that layers of high index of refraction and layers of low index of refraction alternate or that one layer is present, wherein within the layer the index of refraction is gradually changing. It is possible for the weathering resistance to be increased by means of an additional coating, which at the same time causes an optimal adaptation to the binder system (EP-A-268918 and EP-A-632109).

The metal and/or metal oxide coated flakes can be, as described in WO06/131472, treated with a plasma torch. The treatment promotes, for example, uniform crystallinity and/or coating densification. The rapid melting and solidification for certain particles can provide enhanced properties associated with the metal and/or metal oxide coating such as barrier properties, binding properties and crystalline surface formation. The short residence times in the reaction zones allow for rapid treatments. Further the processing conditions can be adjusted to selective melt and resolidificate the surface and near surface of the particles. Moreover, surface leveling can be achieved which results in a uniform surface with minimal defects. Among other things, this may improve the optical properties of the particles.

In one preferred embodiment of the present invention, the interference pigments comprise materials having a “high” index of refraction, which is defined herein as an index of refraction of greater than about 1.65, and optionally materials having a “low” index of refraction, which is defined herein as an index of refraction of about 1.65 or less. Various (dielectric) materials that can be utilized including inorganic materials such as metal oxides, metal suboxides, metal fluorides, metal oxyhalides, metal sulfides, metal chalcogenides, metal nitrides, metal oxynitrides, metal carbides, combinations thereof, and the like, as well as organic dielectric materials. These materials are readily available and easily applied by physical, or chemical vapor deposition processes, or by wet chemical coating processes.

Furthermore, TiO₂-coated flakes may, as described in EP-A-0 982 376, be coated with a nitrogen-doped carbon layer. The process described in EP-A-0 982 376 comprises the following steps:

(a) suspending the SiO₂, or TiO₂ coated flakes in a liquid,
(b) where appropriate adding a surface-modifier and/or a polymerization catalyst,
(c), before or after step (b), adding one or more polymers comprising nitrogen and carbon atoms, or one or more monomers capable of forming such polymers,
(d) forming a polymeric coating on the surface of the flakes,
(e) isolating the coated flakes and
(f) heating the coated flakes to a temperature of from 100 to 600° C. in a gaseous atmosphere.

The polymer may be a polypyrrole, a polyamide, a polyaniline, a polyurethane, a nitrile rubber or a melamine-formaldehyde resin, preferably a polyacrylonitrile, or the monomer is a pyrrole derivative, an acrylonitrile, a methacrylonitrile, a crotonitrile, an acrylamide, a methacrylamide or a crotonamide, preferably an acrylonitrile, methacrylonitrile or crotonitrile, most preferably an acrylonitrile.

Preferably, the flakes are heated in step (f) initially to from 100° C. to 300° C. in an oxygen-containing atmosphere and then to from 200 to 600° C. in an inert gas atmosphere.

The present invention therefore relates also to pigments based on the flakes according to the invention comprising over the entire surface of the titanium oxide coated flakes a layer consisting of from 50 to 95% by weight carbon, from 5 to 25% by weight nitrogen and from 0 to 25% by weight of the elements hydrogen, oxygen and/or sulfur, the percentage by weight data relating to the total weight of the layer (PAN).

The thickness of the nitrogen-doped carbon layer is generally from 10 to 150 nm, preferably from 30 to 70 nm. In said embodiment preferred pigments have the following layer structure: substrate/TiO₂/PAN, substrate/TiO₂/PAN/TiO₂, substrate/TiO₂/PAN/SiO₂/PAN.

In an especially preferred embodiment, the interference pigments on the basis of the substrate of the present invention comprise a further layer of a dielectric material having a “high” refractive index, that is to say a refractive index greater than about 1.65, preferably greater than about 2.0, most preferred greater than about 2.2, which is applied to the entire surface of the glass substrate. Examples of such a dielectric material are zinc sulfide (ZnS), zinc oxide (ZnO), zirconium oxide (ZrO₂), titanium dioxide (TiO₂), carbon, indium oxide (In₂O₃), indium tin oxide (ITO), tantalum pentoxide (Ta₂O₅), chromium oxide (Cr₂O₃), cerium oxide (CeO₂), yttrium oxide (Y₂O₃), europium oxide (Eu₂O₃), iron oxides such as iron(II)/iron(III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon monoxides (SiO), selenium trioxide (Se₂O₃), tin oxide (SnO₂), tungsten trioxide (WO₃), or combinations thereof. The dielectric material is preferably a metal oxide. It being possible for the metal oxide to be a single oxide or a mixture of oxides, with or without absorbing properties, for example, TiO₂, ZrO₂, Fe₂O₃, Fe₃O₄, Cr₂O₃ or ZnO, with TiO₂ being especially preferred.

It is possible to obtain pigments that are more intense in colour and more transparent by applying, on top of the TiO₂ layer, a metal oxide of low refractive index, such as SiO₂, Al₂O₃, AlOOH, B₂O₃ or a mixture thereof, preferably SiO₂, and optionally applying a further TiO₂ layer on top of the latter layer (EP-A-892832, EP-A-753545, WO93/08237, WO98/53011, WO9812266, WO9838254, WO99/20695, WO00/42111, and EP-A-1213330). Nonlimiting examples of suitable low index dielectric materials that can be used include silicon dioxide (SiO₂), aluminum oxide (Al₂O₃), and metal fluorides such as magnesium fluoride (MgF₂), aluminum fluoride (AlF₃), cerium fluoride (CeF₃), lanthanum fluoride (LaF₃), sodium aluminum fluorides (e.g., Na₃AlF₆ or Na₅Al₃F₁₄), neodymium fluoride (NdF₃), samarium fluoride (SmF₃), barium fluoride (BaF₂), calcium fluoride (CaF₂), lithium fluoride (LiF), combinations thereof, or any other low index material having an index of refraction of about 1.65 or less. For example, organic monomers and polymers can be utilized as low index materials, including dienes or alkenes such as acrylates (e.g., methacrylate), polymers of perfluoroalkenes, polytetrafluoroethylene (TEFLON), polymers of fluorinated ethylene propylene (FEP), parylene, p-xylene, combinations thereof, and the like. Additionally, the foregoing materials include evaporated, condensed and cross-linked transparent acrylate layers, which may be deposited by methods described in U.S. Pat. No. 5,877,895, the disclosure of which is incorporated herein by reference.

Accordingly, preferred interference pigments comprise besides (a) a metal oxide of high refractive index in addition (b) a metal oxide of low refractive index, wherein the difference of the refractive indices is at least 0.1.

Pigments on the basis of substrates, which have been coated by a wet chemical method, in the indicated order are particularly preferred:

TiO₂, (SnO₂)TiO₂ (substrate: sheet silicate/metal oxide of low refractive index; layer: (SnO₂)TiO₂, preferably in the rutile modification), Fe₂O₃, Fe₃O₄, TiFe₂O₅, Cr₂O₃, ZrO₂, Sn(Sb)O₂, BiOCl, Al₂O₃, Ce₂S₃, MoS₂, Fe₂O₃.TiO₂ (substrate: sheet silicate/metal oxide of low refractive index; mixed layer of Fe₂O₃ and TiO₂), TiO₂/Fe₂O₃ (substrate: glass; first layer: TiO₂; second layer: Fe₂O₃), TiO₂/Berlin blau, TiO₂/Cr₂O₃, or TiO₂/FeTiO₃. In general the layer thickness ranges from 1 to 1000 nm, preferably from 1 to 300 nm.

In another particularly preferred embodiment the present invention relates to interference pigments containing at least three alternating layers of high and low refractive index, such as, for example, TiO₂/SiO₂/TiO₂, (SnO₂)TiO₂/SiO₂/TiO₂, TiO₂/SiO₂/TiO₂/SiO₂/TiO₂, Fe₂O₃/SiO₂/TiO₂, or TiO₂/SiO₂/Fe₂O₃.

Preferably the layer structure is as follows:

(A) a coating having a refractive index>1.65,
(B) a coating having a refractive index≦1.65,
(C) a coating having a refractive index>1.65, and
(D) optionally an outer protective layer.

The thickness of the individual layers of high and low refractive index on the base substrate is essential for the optical properties of the pigment. The thickness of the individual layers, especially metal oxide layers, depends on the field of use and is generally 10 to 1000 nm, preferably 15 to 800 nm, in particular 20 to 600 nm.

The thickness of layer (A) is 10 to 550 nm, preferably 15 to 400 nm and, in particular, 20 to 350 nm. The thickness of layer (B) is 10 to 1000 nm, preferably 20 to 800 nm and, in particular, 30 to 600 nm. The thickness of layer (C) is 10 to 550 nm, preferably 15 to 400 nm and, in particular, 20 to 350 nm.

Particularly suitable materials for layer (A) are metal oxides, metal sulfides, or metal oxide mixtures, such as TiO₂, Fe₂O₃, TiFe₂O₅, Fe₃O₄, BiOCl, CoO, CO₃O₄, Cr₂O₃, VO₂, V₂O₃, Sn(Sb)O₂, SnO₂, ZrO₂, iron titanates, iron oxide hydrates, titanium suboxides (reduced titanium species having oxidation states from 2 to <4), bismuth vanadate, cobalt aluminate, and also mixtures or mixed phases of these compounds with one another or with other metal oxides. Metal sulfide coatings are preferably selected from sulfides of tin, silver, lanthanum, rare earth metals, preferably cerium, chromium, molybdenum, tungsten, iron, cobalt and/or nickel.

Particularly suitable materials for layer (B) are metal oxides or the corresponding oxide hydrates, such as SiO₂, MgF₂, Al₂O₃, AlOOH, B₂O₃ or a mixture thereof, preferably SiO₂.

Particularly suitable materials for layer (C) are colorless or colored metal oxides, such as TiO₂, Fe₂O₃, TiFe₂O₅, Fe₃O₄, BiOCl, CoO, CO₃O₄, Cr₂O₃, VO₂, V₂O₃, Sn(Sb)O₂, SnO₂, ZrO₂, iron titanates, iron oxide hydrates, titanium suboxides (reduced titanium species having oxidation states from 2 to <4), bismuth vanadate, cobalt aluminate, and also mixtures or mixed phases of these compounds with one another or with other metal oxides. The TiO₂ layers can additionally contain an absorbing material, such as carbon, selectively absorbing colorants, selectively absorbing metal cations, can be coated with absorbing material, or can be partially reduced.

Interlayers of absorbing or nonabsorbing materials can be present between layers (A), (B), (C) and (D). The thickness of the interlayers is 1 to 50 nm, preferably 1 to 40 nm and, in particular, 1 to 30 nm. Such an interlayer can, for example, consist of SnO₂. It is possible to force the rutile structure to be formed by adding small amounts of SnO₂ (see, for example, WO93/08237).

In this embodiment preferred interference pigments have the following layer structure:

| | | | |
|---|---|---|---|
| SUB | TiO₂ | | |
| SUB | (SnO₂)TiO₂ | | |
| SUB | Fe₂O₃ | | |
| SUB | TiO₂/Fe₂O₃ | | |
| SUB | TiO₂ | SiO₂ | TiO₂ |
| SUB | TiO₂ | SiO₂ | Fe₂O₃ |
| SUB | TiO₂ | SiO₂ | TiO₂/Fe₂O₃ |
| SUB | TiO₂ | SiO₂ | (Sn,Sb)O₂ |
| SUB | (Sn,Sb)O₂ | SiO₂ | TiO₂ |
| SUB | Fe₂O₃ | SiO₂ | (Sn,Sb)O₂ |
| SUB | TiO₂/Fe₂O₃ | SiO₂ | TiO₂/Fe₂O₃ |
| SUB | TiO₂ | SiO₂ | MoS₂ |
| SUB | TiO₂ | SiO₂ | Cr₂O₃ |
| SUB | Cr₂O₃ | SiO₂ | TiO₂ |
| SUB | Fe₂O₃ | SiO₂ | TiO₂ |
| SUB | TiO₂ | Al₂O₃ | TiO₂ |
| SUB | Fe₂TiO₅ | SiO₂ | TiO₂ |
| SUB | TiO₂ | SiO₂ | Fe₂TiO₅/TiO₂ |
| SUB | TiO suboxides | SiO₂ | TiO suboxides |
| SUB | TiO₂ | SiO₂ | TiO₂ + SiO₂ + TiO₂ + |
| | | | Prussian Blue |
| SUB | TiO₂ | SiO₂ | TiO₂ + SiO₂ + TiO₂ |
| SUB | TiO₂ + SiO₂ + TiO₂ | SiO₂ | TiO₂ + SiO₂ + TiO₂ |
| TRASUB | STL | TiO₂ | |

wherein SUB is a substrate consisting of a layer of a sheet silicate and a layer of a metal oxide of low refractive index, and
STL is a semi-transparent layer, such as, for example, a semi-transparent metal layer of Cu, Ag, Cr, or Sn, or a semitransparent carbon layer.

The metal oxide layers can be applied by CVD (chemical vapour deposition) or by wet chemical coating. The metal oxide layers can be obtained by decomposition of metal carbonyls in the presence of water vapour (relatively low molecular weight metal oxides such as magnetite) or in the presence of oxygen and, where appropriate, water vapour (e.g. nickel oxide and cobalt oxide). The metal oxide layers are especially applied by means of oxidative gaseous phase decomposition of metal carbonyls (e.g. iron pentacarbonyl, chromium hexacarbonyl; EP-A-45 851), by means of hydrolytic gaseous phase decomposition of metal alcoholates (e.g. titanium and zirconium tetra-n- and -iso-propanoiate; DE-A-41 40 900) or of metal halides (e.g. titanium tetrachloride; EP-A-338 428), by means of oxidative decomposition of organyl tin compounds (especially alkyl tin compounds such as tetrabutyltin and tetramethyltin; DE-A-44 03 678) or by means of the gaseous phase hydrolysis of organyl silicon compounds (especially di-tert-butoxyacetoxysilane) described in EP-A-668 329, it being possible for the coating operation to be carried out in a fluidised-bed reactor (EP-A-045 851 and EP-A-106 235). Al₂O₃ layers (B) can advantageously be obtained by controlled oxidation during the cooling of aluminium-coated pigments, which is otherwise carried out under inert gas (DE-A-195 16 181).

Phosphate-, chromate- and/or vanadate-containing and also phosphate- and SiO₂-containing metal oxide layers can be applied in accordance with the passivation methods described in DE-A-42 36 332 and in EP-A-678 561 by means of hydrolytic or oxidative gaseous phase decomposition of oxide-halides of the metals (e.g. CrO₂Cl₂, VOCl₃), especially of phosphorus oxyhalides (e.g. POCl₃), phosphoric and phosphorous acid esters (e.g. di- and tri-methyl and di- and tri-ethyl phosphite) and of amino-group-containing organyl silicon compounds (e.g. 3-aminopropyl-triethoxy- and -trimethoxy-silane).

Layers of oxides of the metals zirconium, titanium, iron and zinc, oxide hydrates of those metals, iron titanates, titanium suboxides or mixtures thereof are preferably applied by precipitation by a wet chemical method, it being possible, where appropriate, for the metal oxides to be reduced. In the case of the wet chemical coating, the wet chemical coating methods developed for the production of pearlescent pigments may be used; these are described, for example, in DE-A-14 67 468, DE-A-19 59 988, DE-A-20 09 566, DE-A-22 14 545, DE-A-22 15 191, DE-A-22 44 298, DE-A-23 13 331, DE-A-25 22 572, DE-A-31 37 808, DE-A-31 37 809, DE-A-31 51 343, DE-A-31 51 354, DE-A-31 51 355, DE-A-32 11 602 and DE-A-32 35 017, DE 195 99 88, WO 93/08237, WO 98/53001 and WO03/6558.

The metal oxide of high refractive index is preferably TiO₂ and/or iron oxide, and the metal oxide of low refractive index is preferably SiO₂. Layers of TiO₂ can be in the rutile or anastase modification, wherein the rutile modification is preferred. TiO₂ layers can also be reduced by known means, for example ammonia, hydrogen, hydrocarbon vapor or mixtures thereof, or metal powders, as described in EP-A-735,114, DE-A-3433657, DE-A-4125134, EP-A-332071, EP-A-707,050 or WO93/19131.

For the purpose of coating, the substrate particles are suspended in water and one or more hydrolysable metal salts are added at a pH suitable for the hydrolysis, which is so selected that the metal oxides or metal oxide hydrates are precipitated directly onto the particles without subsidiary precipitation occurring. The pH is usually kept constant by simultaneously metering in a base. The pigments are then separated off, washed, dried and, where appropriate, calcinated, it being possible to optimise the calcinating temperature with respect to the coating in question. If desired, after individual coatings have been applied, the pigments can be separated off, dried and, where appropriate, calcinated, and then again re-suspended for the purpose of precipitating further layers.

The metal oxide layers are also obtainable, for example, in analogy to a method described in DE-A-195 01 307, by producing the metal oxide layer by controlled hydrolysis of one or more metal acid esters, where appropriate in the presence of an organic solvent and a basic catalyst, by means of a sol-gel process. Suitable basic catalysts are, for example, amines, such as triethylamine, ethylenediamine, tributylamine, dimethylethanolamine and methoxy-propylamine. The organic solvent is a water-miscible organic solvent such as a C₁₋₄alcohol, especially isopropanol.

Suitable metal acid esters are selected from alkyl and aryl alcoholates, carboxylates, and carboxyl-radical- or alkyl-radical- or aryl-radical-substituted alkyl alcoholates or carboxylates of vanadium, titanium, zirconium, silicon, aluminium and boron. The use of triisopropyl aluminate, tetraisopropyl titanate, tetraisopropyl zirconate, tetraethyl orthosilicate and triethyl borate is preferred. In addition, acetylacetonates and acetoacetylacetonates of the afore-mentioned metals may be used. Preferred examples of that type of metal acid ester are zirconium acetylacetonate, aluminium acetylacetonate, titanium acetylacetonate and diisobutyloleyl acetoacetylaluminate or diisopropyloleyl acetoacetylacetonate and mixtures of metal acid esters, for example Dynasil® (Hüls), a mixed aluminium/silicon metal acid ester.

As a metal oxide having a high refractive index, titanium dioxide is preferably used, the method described in U.S. Pat. No. 3,553,001 being used, in accordance with an embodiment of the present invention, for application of the titanium dioxide layers.

An aqueous titanium salt solution is slowly added to a suspension of the material being coated, which suspension has been heated to about 50-100° C., especially 70-80° C., and a substantially constant pH value of about from 0.5 to 5, especially about from 1.2 to 2.5, is maintained by simultaneously metering in a base such as, for example, aqueous ammonia solution or aqueous alkali metal hydroxide solution. As soon as the desired layer thickness of precipitated TiO₂ has been achieved, the addition of titanium salt solution and base is stopped. Addition of a precursor for Al₂O₃ or MgO in the starting solutions is a way for improving the morphology of the TiO₂ layer.

This method, also referred to as the “titration method”, is distinguished by the fact that an excess of titanium salt is avoided. That is achieved by feeding in for hydrolysis, per unit time, only that amount which is necessary for even coating with the hydrated TiO₂ and which can be taken up per unit time by the available surface of the particles being coated. In principle, the anatase form of TiO₂ forms on the surface of the starting pigment. By adding small amounts of SnO₂, however, it is possible to force the rutile structure to be formed. For example, as described in WO93/08237, tin dioxide can be deposited before titanium dioxide precipitation and the product coated with titanium dioxide can be calcined at from 800 to 900° C.

The TiO₂ can optionally be reduced by usual procedures: U.S. Pat. No. 4,948,631 (NH₃, 750-850° C.), WO93/19131 (H₂, >900° C.) or DE-A-19843014 (solid reduction agent, such as, for example, silicon, >600° C.).

Where appropriate, an SiO₂ (protective) layer can be applied on top of the titanium dioxide layer, for which the following method may be used: A soda waterglass solution is metered into a suspension of the material being coated, which suspension has been heated to about 50-100° C., especially 70-80° C. The pH is maintained at from 4 to 10, preferably from 6.5 to 8.5, by simultaneously adding 10% hydrochloric acid. After addition of the waterglass solution, stirring is carried out for 30 minutes.

It is possible to obtain pigments that are more intense in colour and more transparent by applying, on top of the TiO₂ layer, a metal oxide of “low” refractive index, that is to say a refractive index smaller than about 1.65, such as SiO₂, Al₂O₃, AlOOH, B₂O₃ or a mixture thereof, preferably SiO₂, and applying a further Fe₂O₃ and/or TiO₂ layer on top of the latter layer. Such multi-coated interference pigments comprising a glass substrate and alternating metal oxide layers of with high and low refractive index can be prepared in analogy to the processes described in WO98/53011 and WO99/20695.

It is, in addition, possible to modify the powder colour of the pigment by applying further layers such as, for example, coloured metal oxides or Berlin Blue, compounds of transition metals, e.g. Fe, Cu, Ni, Co, Cr, or organic compounds such as dyes or colour lakes.

In addition, the pigment according to the invention can also be coated with poorly soluble, firmly adhering, inorganic or organic colourants. Preference is given to the use of colour lakes and, especially, aluminium colour lakes. For that purpose an aluminium hydroxide layer is precipitated, which is, in a second step, laked by using a colour lake (DE-A-24 29 762 and DE-A-29 28 287).

Furthermore, the pigment according to the invention may also have an additional coating with complex salt pigments, especially cyanoferrate complexes (EP-A-141 173 and DE-A-23 13 332).

To enhance the weather and light stability the multilayer flakes can be, depending on the field of application, subjected to a surface treatment. Useful surface treatments are, for example, described in DE-A-2215191, DE-A-3151354, DE-A-3235017, DE-A-3334598, DE-A-4030727, EP-A-649886, WO97/29059, WO99/57204, and U.S. Pat. No. 5,759,255. Said surface treatment might also facilitate the handling of the pigment, especially its incorporation into various application media.

In another preferred embodiment the present invention is directed to pigments which comprise a substrate and a mixed layer of Al₂O₃/TiO₂. The mixed layer can contain up to 20 mol % Al₂O₃. The mixed layer of Al₂O₃/TiO₂ is obtained by slowly adding an aqueous aluminum and titanium salt solution to a suspension of the material being coated, which suspension has been heated to about 50-100° C., especially 70-80° C., and maintaining a substantially constant pH value of about from 0.5 to 5, especially about from 1.2 to 2.5, by simultaneously metering in a base such as, for example, aqueous ammonia solution or aqueous alkali metal hydroxide solution. As soon as the desired layer thickness of precipitated Al₂O₃/TiO₂ has been achieved, the addition of titanium and aluminum salt solution and base is stopped.

The thickness of the mixed layer of Al₂O₃/TiO₂ is in general in the range of 20 to 200 nm, especially 50 to 150 nm. Preferably the pigments comprise a TiO₂ layer on top of the mixed layer of Al₂O₃/TiO₂ having a thickness of 1 to 50 nm, especially 10 to 20 nm. By varying the thickness of the mixed layer of Al₂O₃/TiO₂ the flop of the pigments can be enhanced and controlled as desired.

In another preferred embodiment of the present invention is directed to pigments which contain a substrate of the present invention and consist of subsequent layers of TiO₂/SnO₂/TiO₂, wherein the TiO₂ layer next to the glass substrate has a thickness of 1 to 20 nm and is preferably prepared by using titanium alcoholates, especially tetraisopropyl titanate.

If the substrates of the present invention are used, interference pigments having superior brilliance, clear and intense colors, intense color flop, improved color strength and/or color purity can be obtained. An improved mechanical resistance is also observed.

Metallic or non-metallic, inorganic platelet-shaped particles or pigments are effect pigments, (especially metal effect pigments or interference pigments), that is to say, pigments that, besides imparting colour to an application medium, impart additional properties, for example angle dependency of the colour (flop), lustre (not surface gloss) or texture. On metal effect pigments, substantially oriented reflection occurs at directionally oriented pigment particles. In the case of interference pigments, the colour-imparting effect is due to the phenomenon of interference of light in thin, highly refractive layers.

The (effect) pigments according to the invention can be used for all customary purposes, for example for colouring polymers in the mass, coatings (including effect finishes, including those for the automotive sector) and printing inks (including offset printing, intaglio printing, bronzing and flexographic printing), and also, for example, for applications in cosmetics, in ink-jet printing, for dyeing textiles, glazes for ceramics and glass as well as laser marking of papers and plastics. Such applications are known from reference works, for example “Industrielle Organische Pigmente” (W. Herbst and K. Hunger, VCH Verlagsgesellschaft mbH, Weinheim/New York, 2nd, completely revised edition, 1995).

When the pigments according to the invention are interference pigments (effect pigments), they may be goniochromatic and result in brilliant, highly saturated (lustrous) colours. They are accordingly very especially suitable for combination with conventional, transparent pigments, for example organic pigments such as, for example, diketopyrrolopyrroles, quinacridones, dioxazines, perylenes, isoindolinones etc., it being possible for the transparent pigment to have a similar colour to the effect pigment. Especially interesting combination effects are obtained, however, in analogy to, for example, EP-A-388 932 or EP-A-402 943, when the colour of the transparent pigment and that of the effect pigment are complementary.

The pigments according to the invention can be used with excellent results for pigmenting high molecular weight organic material.

The high molecular weight organic material for the pigmenting of which the pigments or pigment compositions according to the invention may be used may be of natural or synthetic origin. High molecular weight organic materials usually have molecular weights of about from 10³ to 10⁸ g/mol or even more. They may be, for example, natural resins, drying oils, rubber or casein, or natural substances derived therefrom, such as chlorinated rubber, oil-modified alkyd resins, viscose, cellulose ethers or esters, such as ethylcellulose, cellulose acetate, cellulose propionate, cellulose acetobutyrate or nitrocellulose, but especially totally synthetic organic polymers (thermosetting plastics and thermoplastics), as are obtained by polymerisation, polycondensation or polyaddition. From the class of the polymerisation resins there may be mentioned, especially, polyolefins, such as polyethylene, polypropylene or polyisobutylene, and also substituted polyolefins, such as polymerisation products of vinyl chloride, vinyl acetate, styrene, acrylonitrile, acrylic acid esters, methacrylic acid esters or butadiene, and also copolymerisation products of the said monomers, such as especially ABS or EVA.

From the series of the polyaddition resins and polycondensation resins there may be mentioned, for example, condensation products of formaldehyde with phenols, so-called phenoplasts, and condensation products of formaldehyde with urea, thiourea or melamine, so-called aminoplasts, and the polyesters used as surface-coating resins, either saturated, such as alkyd resins, or unsaturated, such as maleate resins; also linear polyesters and polyamides, polyurethanes or silicones.

The said high molecular weight compounds may be present singly or in mixtures, in the form of plastic masses or melts. They may also be present in the form of their monomers or in the polymerised state in dissolved form as film-formers or binders for coatings or printing inks, such as, for example, boiled linseed oil, nitrocellulose, alkyd resins, melamine resins and urea-formaldehyde resins or acrylic resins.

Depending on the intended purpose, it has proved advantageous to use the effect pigments or effect pigment compositions according to the invention as toners or in the form of preparations. Depending on the conditioning method or intended application, it may be advantageous to add certain amounts of texture-improving agents to the effect pigment before or after the conditioning process, provided that this has no adverse effect on use of the effect pigments for colouring high molecular weight organic materials, especially polyethylene. Suitable agents are, especially, fatty acids containing at least 18 carbon atoms, for example stearic or behenic acid, or amides or metal salts thereof, especially magnesium salts, and also plasticisers, waxes, resin acids, such as abietic acid, rosin soap, alkylphenols or aliphatic alcohols, such as stearyl alcohol, or aliphatic 1,2-dihydroxy compounds containing from 8 to 22 carbon atoms, such as 1,2-dodecanediol, and also modified colophonium maleate resins or fumaric acid colophonium resins. The texture-improving agents are added in amounts of preferably from 0.1 to 30% by weight, especially from 2 to 15% by weight, based on the end product.

The (effect) pigments according to the invention can be added in any tinctorially effective amount to the high molecular weight organic material being pigmented. A pigmented substance composition comprising a high molecular weight organic material and from 0.01 to 80% by weight, preferably from 0.1 to 30% by weight, based on the high molecular weight organic material, of an pigment according to the invention is advantageous. Concentrations of from 1 to 20% by weight, especially of about 10% by weight, can often be used in practice.

High concentrations, for example those above 30% by weight, are usually in the form of concentrates (“masterbatches”) which can be used as colorants for producing pigmented materials having a relatively low pigment content, the pigments according to the invention having an extraordinarily low viscosity in customary formulations so that they can still be processed well.

For the purpose of pigmenting organic materials, the effect pigments according to the invention may be used singly. It is, however, also possible, in order to achieve different hues or colour effects, to add any desired amounts of other colour-imparting constituents, such as white, coloured, black or effect pigments, to the high molecular weight organic substances in addition to the effect pigments according to the invention. When coloured pigments are used in admixture with the effect pigments according to the invention, the total amount is preferably from 0.1 to 10% by weight, based on the high molecular weight organic material. Especially high goniochromicity is provided by the preferred combination of an effect pigment according to the invention with a coloured pigment of another colour, especially of a complementary colour, with colorations made using the effect pigment and colorations made using the coloured pigment having, at a measurement angle of 10°, a difference in hue (ΔH*) of from 20 to 340, especially from 150 to 210.

Preferably, the effect pigments according to the invention are combined with transparent coloured pigments, it being possible for the transparent coloured pigments to be present either in the same medium as the effect pigments according to the invention or in a neighbouring medium. An example of an arrangement in which the effect pigment and the coloured pigment are advantageously present in neighbouring media is a multi-layer effect coating.

The pigmenting of high molecular weight organic substances with the pigments according to the invention is carried out, for example, by admixing such a pigment, where appropriate in the form of a masterbatch, with the substrates using roll mills or mixing or grinding apparatuses. The pigmented material is then brought into the desired final form using methods known per se, such as calendering, compression moulding, extrusion, coating, pouring or injection moulding. Any additives customary in the plastics industry, such as plasticisers, fillers or stabilisers, can be added to the polymer, in customary amounts, before or after incorporation of the pigment. In particular, in order to produce non-rigid shaped articles or to reduce their brittleness, it is desirable to add plasticisers, for example esters of phosphoric acid, phthalic acid or sebacic acid, to the high molecular weight compounds prior to shaping.

For pigmenting coatings and printing inks, the high molecular weight organic materials and the effect pigments according to the invention, where appropriate together with customary additives such as, for example, fillers, other pigments, siccatives or plasticisers, are finely dispersed or dissolved in the same organic solvent or solvent mixture, it being possible for the individual components to be dissolved or dispersed separately or for a number of components to be dissolved or dispersed together, and only thereafter for all the components to be brought together.

Dispersing an effect pigment according to the invention in the high molecular weight organic material being pigmented, and processing a pigment composition according to the invention, are preferably carried out subject to conditions under which only relatively weak shear forces occur so that the effect pigment is not broken up into smaller portions.

Plastics comprising the pigment of the invention in amounts of 0.1 to 50% by weight, in particular 0.5 to 7% by weight. In the coating sector, the pigments of the invention are employed in amounts of 0.1 to 10% by weight. In the pigmentation of binder systems, for example for paints and printing inks for intaglio, offset or screen printing, the pigment is incorporated into the printing ink in amounts of 0.1 to 50% by weight, preferably 5 to 30% by weight and in particular 8 to 15% by weight.

The colorations obtained, for example in plastics, coatings or printing inks, especially in coatings or printing inks, more especially in coatings, may be distinguished by excellent properties, especially by extremely high saturation, outstanding fastness properties, high color purity and high goniochromicity.

When the high molecular weight material being pigmented is a coating, it is especially a speciality coating, very especially an automotive finish.

The effect pigments according to the invention are also suitable for making-up the lips or the skin and for colouring the hair or the nails.

The invention accordingly relates also to a cosmetic preparation or formulation comprising from 0.0001 to 90% by weight of a pigment, especially an effect pigment, according to the invention and from 10 to 99.9999% of a cosmetically suitable carrier material, based on the total weight of the cosmetic preparation or formulation.

Such cosmetic preparations or formulations are, for example, lipsticks, blushers, foundations, nail varnishes and hair shampoos.

The pigments may be used singly or in the form of mixtures. It is, in addition, possible to use pigments according to the invention together with other pigments and/or colorants, for example in combinations as described hereinbefore or as known in cosmetic preparations. The cosmetic preparations and formulations according to the invention preferably contain the pigment according to the invention in an amount from 0.005 to 50% by weight, based on the total weight of the preparation.

Suitable carrier materials for the cosmetic preparations and formulations according to the invention include the customary materials used in such compositions.

The cosmetic preparations and formulations according to the invention may be in the form of, for example, sticks, ointments, creams, emulsions, suspensions, dispersions, powders or solutions. They are, for example, lipsticks, mascara preparations, blushers, eye-shadows, foundations, eyeliners, powder or nail varnishes.

If the preparations are in the form of sticks, for example lipsticks, eye-shadows, blushers or foundations, the preparations consist for a considerable part of fatty components, which may consist of one or more waxes, for example ozokerite, lanolin, lanolin alcohol, hydrogenated lanolin, acetylated lanolin, lanolin wax, beeswax, candelilla wax, microcrystalline wax, carnauba wax, cetyl alcohol, stearyl alcohol, cocoa butter, lanolin fatty acids, petrolatum, petroleum jelly, mono-, di- or tri-glycerides or fatty esters thereof that are solid at 25° C., silicone waxes, such as methyloctadecane-oxypolysiloxane and poly(dimethylsiloxy)-stearoxysiloxane, stearic acid monoethanolamine, colophane and derivatives thereof, such as glycol abietates and glycerol abietates, hydrogenated oils that are solid at 25° C., sugar glycerides and oleates, myristates, lanolates, stearates and dihydroxystearates of calcium, magnesium, zirconium and aluminium.

The fatty component may also consist of a mixture of at least one wax and at least one oil, in which case the following oils, for example, are suitable: paraffin oil, purcelline oil, perhydrosqualene, sweet almond oil, avocado oil, calophyllum oil, castor oil, sesame oil, jojoba oil, mineral oils having a boiling point of about from 310 to 410° C., silicone oils, such as dimethylpolysiloxane, linoleyl alcohol, linolenyl alcohol, oleyl alcohol, cereal grain oils, such as wheatgerm oil, isopropyl lanolate, isopropyl palmitate, isopropyl myristate, butyl myristate, cetyl myristate, hexadecyl stearate, butyl stearate, decyl oleate, acetyl glycerides, octanoates and decanoates of alcohols and polyalcohols, for example of glycol and glycerol, ricinoleates of alcohols and polyalcohols, for example of cetyl alcohol, isostearyl alcohol, isocetyl lanolate, isopropyl adipate, hexyl laurate and octyl dodecanol.

The fatty components in such preparations in the form of sticks may generally constitute up to 99.91% by weight of the total weight of the preparation.

The cosmetic preparations and formulations according to the invention may additionally comprise further constituents, such as, for example, glycols, polyethylene glycols, polypropylene glycols, monoalkanolamides, non-coloured polymeric, inorganic or organic fillers, preservatives, UV filters or other adjuvants and additives customary in cosmetics, for example a natural or synthetic or partially synthetic di- or tri-glyceride, a mineral oil, a silicone oil, a wax, a fatty alcohol, a Guerbet alcohol or ester thereof, a lipophilic functional cosmetic active ingredient, including sun-protection filters, or a mixture of such substances. A lipophilic functional cosmetic active ingredient suitable for skin cosmetics, an active ingredient composition or an active ingredient extract is an ingredient or a mixture of ingredients that is approved for dermal or topical application. The following may be mentioned by way of example:
active ingredients having a cleansing action on the skin surface and the hair; these include all substances that serve to cleanse the skin, such as oils, soaps, synthetic detergents and solid substances;
active ingredients having a deodorising and perspiration-inhibiting action: they include antiperspirants based on aluminium salts or zinc salts, deodorants comprising bactericidal or bacteriostatic deodorising substances, for example triclosan, hexachlorophene, alcohols and cationic substances, such as, for example, quaternary ammonium salts, and odour absorbers, for example ®Grillocin (combination of zinc ricinoleate and various additives) or triethyl citrate (optionally in combination with an antioxidant, such as, for example, butyl hydroxytoluene) or ion-exchange resins;
active ingredients that offer protection against sunlight (UV filters): suitable active ingredients are filter substances (sunscreens) that are able to absorb UV radiation from sunlight and convert it into heat; depending on the desired action, the following light-protection agents are preferred: light-protection agents that selectively absorb sunburn-causing high-energy UV radiation in the range of approximately from 280 to 315 nm (UV-B absorbers) and transmit the longer-wavelength range of, for example, from 315 to 400 nm (UV-A range), as well as light-protection agents that absorb only the longer-wavelength radiation of the UV-A range of from 315 to 400 nm (UV-A absorbers); suitable light-protection agents are, for example, organic UV absorbers from the class of the p-aminobenzoic acid derivatives, salicylic acid derivatives, benzophenone derivatives, dibenzoylmethane derivatives, diphenyl acrylate derivatives, benzofuran derivatives, polymeric UV absorbers comprising one or more organosilicon radicals, cinnamic acid derivatives, camphor derivatives, trianilino-s-triazine derivatives, phenyl-benzimidazolesulfonic acid and salts thereof, menthyl anthranilates, benzotriazole derivatives, and/or an inorganic micropigment selected from aluminium oxide- or silicon dioxide-coated TiO₂, zinc oxide or mica;
active ingredients against insects (repellents) are agents that are intended to prevent insects from touching the skin and becoming active there; they drive insects away and evaporate slowly; the most frequently used repellent is diethyl toluamide (DEET); other common repellents will be found, for example, in “Pflegekosmetik” (W. Raab and U. Kindl, Gustav-Fischer-Verlag Stuttgart/New York, 1991) on page 161;
active ingredients for protection against chemical and mechanical influences: these include all substances that form a barrier between the skin and external harmful substances, such as, for example, paraffin oils, silicone oils, vegetable oils, PCL products and lanolin for protection against aqueous solutions, film-forming agents, such as sodium alginate, triethanolamine alginate, polyacrylates, polyvinyl alcohol or cellulose ethers for protection against the effect of organic solvents, or substances based on mineral oils, vegetable oils or silicone oils as “lubricants” for protection against severe mechanical stresses on the skin;
moisturising substances: the following substances, for example, are used as moisture-controlling agents (moisturisers): sodium lactate, urea, alcohols, sorbitol, glycerol, propylene glycol, collagen, elastin and hyaluronic acid;
active ingredients having a keratoplastic effect: benzoyl peroxide, retinoic acid, colloidal sulfur and resorcinol;
antimicrobial agents, such as, for example, triclosan or quaternary ammonium compounds;
oily or oil-soluble vitamins or vitamin derivatives that can be applied dermally: for example vitamin A (retinol in the form of the free acid or derivatives thereof), panthenol, pantothenic acid, folic acid, and combinations thereof, vitamin E (tocopherol), vitamin F; essential fatty acids; or niacinamide (nicotinic acid amide);
vitamin-based placenta extracts: active ingredient compositions comprising especially vitamins A, C, E, B₁, B₂, B₆, B₁₂, folic acid and biotin, amino acids and enzymes as well as compounds of the trace elements magnesium, silicon, phosphorus, calcium, manganese, iron or copper;
skin repair complexes: obtainable from inactivated and disintegrated cultures of bacteria of the bifidus group;
plants and plant extracts: for example arnica, aloe, beard lichen, ivy, stinging nettle, ginseng, henna, camomile, marigold, rosemary, sage, horsetail or thyme;
animal extracts: for example royal jelly, propolis, proteins or thymus extracts;
cosmetic oils that can be applied dermally: neutral oils of the Miglyol 812 type, apricot kernel oil, avocado oil, babassu oil, cottonseed oil, borage oil, thistle oil, groundnut oil, gamma-oryzanol, rosehip-seed oil, hemp oil, hazelnut oil, blackcurrant-seed oil, jojoba oil, cherry-stone oil, salmon oil, linseed oil, cornseed oil, macadamia nut oil, almond oil, evening primrose oil, mink oil, olive oil, pecan nut oil, peach kernel oil, pistachio nut oil, rape oil, rice-seed oil, castor oil, safflower oil, sesame oil, soybean oil, sunflower oil, tea tree oil, grapeseed oil or wheatgerm oil.

The preparations in stick form are preferably anhydrous but may in certain cases comprise a certain amount of water which, however, in general does not exceed 40% by weight, based on the total weight of the cosmetic preparation.

If the cosmetic preparations and formulations according to the invention are in the form of semi-solid products, that is to say in the form of ointments or creams, they may likewise be anhydrous or aqueous. Such preparations and formulations are, for example, mascaras, eyeliners, foundations, blushers, eye-shadows, or compositions for treating rings under the eyes.

If, on the other hand, such ointments or creams are aqueous, they are especially emulsions of the water-in-oil type or of the oil-in-water type that comprise, apart from the pigment, from 1 to 98.8% by weight of the fatty phase, from 1 to 98.8% by weight of the aqueous phase and from 0.2 to 30% by weight of an emulsifier.

Such ointments and creams may also comprise further conventional additives, such as, for example, perfumes, antioxidants, preservatives, gel-forming agents, UV filters, colorants, pigments, pearlescent agents, non-coloured polymers as well as inorganic or organic fillers. If the preparations are in the form of a powder, they consist substantially of a mineral or inorganic or organic filler such as, for example, talcum, kaolin, starch, polyethylene powder or polyamide powder, as well as adjuvants such as binders, colorants etc.

Such preparations may likewise comprise various adjuvants conventionally employed in cosmetics, such as fragrances, antioxidants, preservatives etc.

If the cosmetic preparations and formulations according to the invention are nail varnishes, they consist essentially of nitrocellulose and a natural or synthetic polymer in the form of a solution in a solvent system, it being possible for the solution to comprise other adjuvants, for example pearlescent agents.

In that embodiment, the coloured polymer is present in an amount of approximately from 0.1 to 5% by weight.

The cosmetic preparations and formulations according to the invention may also be used for colouring the hair, in which case they are used in the form of shampoos, creams or gels that are composed of the base substances conventionally employed in the cosmetics industry and a pigment according to the invention.

The cosmetic preparations and formulations according to the invention are prepared in conventional manner, for example by mixing or stirring the components together, optionally with heating so that the mixtures melt.

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLE 1

### Substrate Preparation

### a) SiO₂ Coating of Raw Mica Flakes

Raw natural mica (muscovite) chips (mm or more in diameter and thicker than 5 microns) are milled and sieved to get flatly particles with 50 to 500 microns in diameters and about 5 microns or more in thickness). Then a quantity corresponding to about 20 m² of the sieved flatly particles’ (effective surface area ˜(0.1 to 1 m²/gr) is mixed up with 300 ml isopropanol in a sulfonation reactor equipped with a mechanical stirrer. Following addition of 30 ml of water, 0.16 g of CTAB (cetyltrimethylammonium bromide bought from Acros) and 1.8 ml of a 28% aqueous ammonia solution, the suspension is heated at 60° C. stirring vigorously. At this time the metered addition is commenced of a mixture of 30 ml of tetraethoxysilane with 30 ml isopropanol at a rate of 1 ml/min. The mixture is stirred at 60° C. overnight. After cooling down the product is filtered, washed with isopropanol and dried at 80° C. for an hour.

b) Exfoliation of SiO₂ from the Mica

The dried powder is then heated at 500° C. in air during 5 hours, cooled down and soaked in distilled water for 24 hours with gently stirring. Then the suspension is filtered to get a paste which is not dried. This paste (SiO₂ coated, water saturated mica flakes) are mixed with a viscous liquid (flowing honey) in a ratio 1:3. This highly viscous mixture is handled at room temperature with a three roll mill till the SiO₂ coating exfoliates from the mica substrate. The stand alone SiO₂ coated mica flakes (some alumino-silicate sheets from the starting mica remained on one side of the SiO₂) are separated from the remaining mica by sedimentation and dried.

Coating of New Substrate with TiO₂

4.5 g of such reinforced SiO₂ flakes are mixed with 300 ml distilled water in a closed reactor and heated at 75° C. The pH is set to 1.6 and the suspension is stirred at 350 rpm for 15 minutes. Then a preparation comprising 9 g SnCl₄.5H₂O dissolved in 5 g HCl (37%) and 100 g distilled water is added (0.8 ml/minutes) during 15 minutes while stirring at 350 rpm. Then the suspension is heated at 90° C. while stirring during additional 15 minutes. Then the pH is set to 2.0 and a preparation comprising 34 g from TiOCl₂, 32 g of HCl (37%) and 445 g of distilled water is added at a rate of 0.8 ml/minutes during 6 hours. The powder obtained after filtration and drying features a bright blue colour shifting to magenta with increasing viewing angle. The product is calcinated at 500° C. in air for 6 hours. X-ray diffraction spectroscopy shows that the TiO₂ is present in the rutile modification and elemental analysis shows that the product contains 0.92% by weight Sn and 35.4% by weight of Ti.

1. A method for preparing a (pearlescent) pigment, comprising the steps of:
(1) coating of a sheet silicate with a desired metal oxide, wherein coated flakes are obtained,
(2) delamination of the coated flakes obtained in step (1), wherein exfoliated coated flakes and exfoliated non-coated flakes are obtained,
(3) separation of the exfoliated coated flakes from the exfoliated non-coated flakes,
(4) coating the exfoliated coated flakes obtained in step (3) with metals, metal oxides, metal sulfides, metal nitrides or mixtures thereof, wherein a (pearlescent) pigment is obtained.

2. The method of claim 1, wherein the metal oxide in step (1) is a metal oxide of low refractive index.

3. The method of claim 1, wherein the exfoliated coated flakes obtained in step (3) are coated with a metal oxide of high refractive index.

4. The method of claim 1, wherein the sheet silicate is natural and/or expandable synthetic mica.

5. The method of claim 1, wherein the sheet silicate is natural mica (muscovite), or a phyllosilicate (vermiculite) with 50 to 500 microns in diameter and about 5 microns or more in thickness, which is obtained by milling and sieving raw natural mica chips.

6. The method of claim 5, wherein in step (1) the mica particles are dispersed in water in the presence of a cationic, anionic, nonionic or amphionic surfactant at an alkaline pH and at elevated temperature and a tetraalkoxy silane is added thereto, wherein a hydrous silicon oxide layer on the particles of the sheet silicate particles is formed.

7. The method of claim 6, wherein in step (2) water saturated SiO₂ coated mica flakes obtained in step (1) are mixed with a viscous liquid having Brookfield viscosity of 0.1 to 10³ Pa*s and treated with a three roll mill until SiO₂ coated exfoliated mica flakes are obtained.

8. The method of claim 7, wherein the viscous liquid is selected from a mixture of sugar and water, or a polymer having OH groups.

9. The method of claim 8, wherein in step (3) SiO₂ coated exfoliated mica flakes are coated with titanium dioxide in hydrous form at acid pH by deposition from a titanium salt containing coating bath at a low pH.

10. A pearlescent pigment, obtained by the process according to claim 1.

11. (canceled)

12. Paints, printing inks, plastics, cosmetics, ceramics and glass, which are pigmented with a pigment according to claim 10.

13. The method of claim 2, wherein the metal oxide of low refractive index is SiO₂, Al₂O₃, AlOOH, B₂O₃ or a mixture thereof.

13. The method of claim 13, wherein the metal oxide of low refractive index is SiO₂.

14. The method of claim 3, wherein the metal oxide of high refractive index is CeO₂, TiO₂, ZrO₂, Fe₂O₃, Fe₃O₄, Cr₂O₃ or ZnO.

15. The method of claim 2, wherein the exfoliated coated flakes obtained in step (3) are coated with a metal oxide of high refractive index.

16. The method of claim 15, wherein the metal oxide of high refractive index is CeO₂, TiO₂, ZrO₂, Fe₂O₃, Fe₃O₄, Cr₂O₃ or ZnO.

17. A pearlescent pigment, obtained by the process according to claim 2.

18. A pearlescent pigment, obtained by the process according to claim 3.

19. A pearlescent pigment, obtained by the process according to claim 5.

20. A pearlescent pigment, obtained by the process according to claim 8.

21. A pearlescent pigment, obtained by the process according to claim 9.
